(19) United States
(12) Patent Application Publication
(10) Pub. No.: US 2011/0214462 A1
(43) Pub. Date: Sep. 8, 2011

(54) Anti-Bump Top Pin for Pin Tumbler Locks

(75) Inventors: John Loughlin, Lebanon, NJ (US); Robert Loughlin, Stanton, NJ (US); Arthur L. Arledge, Basking Ridge, NJ (US)

(73) Assignee: Stanton Concepts Inc., Stanton, NJ (US)

(21) Appl. No.: 13/017,470

(22) Filed: Jan. 31, 2011

Related U.S. Application Data
(60) Provisional application No. 61/309,674, filed on Mar. 2, 2010.

(51) Int. Cl. E05B 27/04

(52) U.S. Cl. 70/493

(57) ABSTRACT

A pin tumbler lock is key bump resistant by applying a top pin that has an at least partially walled tubular hollow structure. The hollow top pin is reduced in weight compared to a standard top pin. In one embodiment of the present invention the top pin is made longer than a top pin in a pin tumbler lock of standard construction. In a further embodiment of the present invention the pin tumbler lock has a compound spring in a common chamber of the pin tumbler lock. A top pin in one embodiment of the present invention is made of titanium. The top pin in a further embodiment of the present invention is part of a kit. The kit may have installation instructions. The kit may also have packaging. The pin tumbler lock in one embodiment of the present invention has a combination pin that is substantially heavier than a pin tumbler lock in a known embodiment. The pin tumbler lock may be a door lock, a container lock, a padlock or a car lock or any other lock that is subject to bumping.

### CROSS REFERENCE TO RELATED APPLICATIONS

The present application claims the benefit of U.S. Provisional Patent Application Ser. No. 61/309,674 filed on Mar. 2, 2010, which is incorporated herein by reference in its entirety.

### BACKGROUND OF THE INVENTION

Aspects of the present invention relate to pin tumbler locks and more in particular to make a pin tumbler lock more resistant to opening by a key bumping or lock bumping attack.

Pin tumbler locks are widely applied and relied upon to provide security of personal safety, to protect property against theft and prevent buildings from unauthorized entering. Pin tumbler locks are applied in padlocks, door locks, storage locks, car locks and in many other locking systems. A pin tumbler lock, in general, provides a sufficient level of security and protection against many forms of attacks at a reasonable price. Unfortunately, a pin tumbler lock is known to be relatively easily opened by an attack known as “key bumping” or “lock bumping.” By applying a modified key that is inserted into a pin tumbler lock and applying a knock or rap on the modified key, a gap is known to be created between top pins and combination pins at the shear line of the lock that allows the lock to be opened surreptitiously by an attacker.

The “key bumping” attack requires very little training by the attacker, and can be executed quickly and effectively by virtually any malfeasant on a majority of known pin tumbler locks, thus making the locks virtually ineffective against low skilled attacks. The nature of the attacks also makes it difficult to detect a “key bumping” attack after the fact. Thus, when a breach of security in a lock protected property has been detected it is difficult to assess how a malfeasant has actually circumvented the lock, as a “bumped” lock may show very limited and hard to detect indications that the lock has been “bumped.”

One effective way to address and to protect a lock from “key bumping” is to apply a lock that does not apply tumbler pins. For instance, combination locks using tumbler wheels may be a solution. A tool operated combination lock as disclosed in U.S. patent application Ser. No. 11/186,698, filed on Jul. 21, 2005 entitled “Tool operated combination lock” and which is incorporated herein by reference, is bump proof and may be a preferred lock in security demanding applications. However, there are millions of pin tumbler locks installed with specific keys. In many cases, pin tumbler lock users may want to upgrade their locks to be better resistant to “bump” attacks, while being able if desired to use the same keys as in the unmodified locks.

Accordingly, novel and improved “key bumping” resisting pin tumbler locks and indicators for indicating a “key bumping” attack are required.

### SUMMARY OF THE INVENTION

In accordance with one embodiment of the present invention, a key bumping or lock bumping pin tumbler lock is provided. In one embodiment of the present invention resistance to opening by key bumping is achieved by decreasing a weight ratio between top pin and combination pin. In one embodiment of the present invention this is achieved by lowering the weight of the top pin. In another embodiment of the present invention this is achieved by increasing the weight of the combination pin. In another embodiment of the present invention resistance is achieved by decreasing the length of the top pin. In another embodiment of the present invention resistance is achieved by increasing the length of the top pin. In another embodiment of the present invention resistance is achieved by increasing the distance a top pin travels. In another embodiment of the present invention resistance is achieved by decreasing the distance a top pin travels.

In a further embodiment of the present invention the top of an improved top pin stops at a ceiling of the chamber of a lock before the associated spring is fully compressed.

In yet a further embodiment of the present invention a pin tumbler lock is provided, wherein at least one of the top pin that has a hollowed section is about 50% longer than a length of the combination pin associated with the top pin.

In yet a further embodiment of the present invention a pin tumbler lock is provided, wherein at least one of the top pins has a hollowed section that is about 50% longer than a length of the unimproved top pins in the same lock assembly.

In yet a further embodiment of the present invention a pin tumbler lock is provided, wherein at least one of the top pins has a length that is 1.25×, or the same length or 0.75×, or 0.5× or 0.25× of the length of the combination pin associated with the top pin.

In yet a further embodiment of the present invention method is provided to determine in a bump resistant tumbler lock an optimum length of improved top pin to maximize time the shear line is blocked to minimize bumping opportunity.

In yet a further embodiment of the present invention a pin tumbler lock is provided, wherein an improved top pin and springs are part of a kit for retrofitting an existing lock.

In yet a further embodiment of the present invention a pin tumbler lock is provided, further comprising a plug with a feature to trap a combination pin during a bumping attack.

In yet a further embodiment of the present invention a pin tumbler lock is provided, which captures the bump key and “Lock Out” the lock.

In yet a further embodiment of the present invention a pin tumbler lock is provided, further comprising a nose feature on combination pin that hinders traditional picking attack.

In yet a further embodiment of the present invention a pin tumbler lock is provided, further comprising an asymmetric hole on bottom of improved top pin to absorb energy and also hinders traditional picking attack.

In yet a further embodiment of the present invention a pin tumbler lock is provided, further comprising an improved top pin with compound spring. One working spring rate and one very high spring rate to absorb the energy during a bumping attack. A compound spring is possible because of the longer spring length allowed by the hollow top pin.

In addition one embodiment of the present invention of the invention provides a means to prevent a fully successful bump attack and capture the bump key in the lock cylinder.

### DESCRIPTION OF THE DRAWINGS

FIG. 1a illustrates a pin tumbler lock.

FIG. 1b illustrates a pin tumbler lock with a key inserted into it.

FIG. 1c illustrates a pin tumbler lock with a key and plug partially turned.

FIG. 2a illustrates a pin tumbler lock with one embodiment of the present invention of an improved top pin in one chamber.

FIG. 2b illustrates a pin tumbler lock with one embodiment of the present invention of an improved top pin in one chamber with a key inserted into it.

FIG. 2a illustrates a pin tumbler lock with one embodiment of an improved top pin in one chamber with a key and plug partially turned.

FIG. 3 illustrates a pin tumbler lock in accordance with one aspect of the present invention with a bump key inserted

FIG. 4 illustrates a key cut for a five pin tumbler cylinder.

FIG. 5 illustrates a bump key for pin a five tumbler cylinder.

FIG. 6 illustrates a five pin tumbler lock populated with a variety of top pins.

FIG. 7 illustrates a pin tumbler lock in accordance with another aspect of the present invention during a bumping attack

FIG. 8a illustrates a top pin in accordance with an aspect of the present invention.

FIG. 8b illustrates a top pin in accordance with another aspect of the present invention.

FIG. 8c illustrates a top pin in accordance with a further aspect of the present invention.

FIG. 8d illustrates a top pin in accordance with a further aspect of the present invention.

FIG. 8e illustrates a top pin in accordance with yet another aspect of the present invention.

FIG. 9 illustrates a prior art top pin.

FIG. 10 illustrates a top pin in accordance with another aspect of the present invention that includes a tab protruding from a top end of the top pin.

FIG. 11 illustrates a top pin in accordance with another aspect of the present invention that includes a stepped portion on the bottom of the top pin.

FIG. 12 illustrates a top pin in accordance with another aspect of the present invention that includes an angled bottom surface.

FIG. 13 illustrates the arrangement of the top pin shown in FIG. 8d, including a combination pin and a spring.

FIG. 14a is a chart that illustrates the relative distance of the combination pin associated with the unimproved top pin and the combination pin associated with an improved top pin of the same length during a bump attack.

FIG. 14b is a chart that illustrates the relative distance of the combination pin associated with the unimproved top pin and the combination pin associated with a longer improved top pin during a bump attack.

FIG. 14c is a chart that illustrates the relative distance of the combination pin associated with the unimproved top pin and the combination pin associated with a shorter improved top pin during a bump attack.

FIG. 15 illustrates a plug in accordance with an aspect of this invention.

FIG. 16 illustrates a combination pin in accordance with an aspect of this invention.

FIG. 17a illustrates a pin tumbler lock in accordance with another aspect of this invention.

FIG. 17b illustrates a pin tumbler lock in accordance with an aspect of this invention.

### DESCRIPTION

A surreptitious attack on pin tumbler locks now commonly referred to as key bumping has been around for a long time. In 1925 George Baron was granted British patent 251,810 for bump key technology and a device to perform the attack was patented in 1928 by Hiram Simpson, in U.S. Pat. No. 1,667,223, both of which are incorporated herein by reference. Recently the method has gained notoriety through the internet. Han Fey and Barry Wels of TOOOL (The Open Organization Of Lockpickers) contributed to the public's awareness of the vulnerability, others have also made important contributions to create public awareness. An article by Barry Wels and Han Fey, “Bumping locks”, Jan. 26, 2005, published by TOOOL on-line on their website, which is incorporated herein by reference, provides an overview of “lock bumping.” The article “OPENING LOCKS BY BUMPING IN FIVE SECONDS OR LESS: IS IT REALLY A THREAT TO PHYSICAL SECURITY? A TECHNICAL ANALYSIS OF THE ISSUES” by M. W. Tobias, released on-line on Apr. 4, 2006, and incorporated herein by reference, also provides details on “lock bumping.” Billy Edwards, CML, wrote an excellent paper titled “New Anti-Bump Technology” that outlines the history kinetics and possible remedies for bumping attacks.

The terms “key bumping” and “lock bumping” can be used interchangeably. To be consistent, the term “key bumping” or key bumping will be used from this point forward, with the understanding that other terms may also apply.

Lately, the details of key bumping of pin tumbler locks have become widely known and accessible, for instance via the Internet. Since coming out into the open several approaches have been attempted to address the vulnerability of pin tumbler locks to bumping attacks. Aspects of the invention as disclosed herein have advantages over the prior art including the ability to retrofit existing locks, low cost, readily manufacturable, adaptable to all pin tumbler cylinders, preventing damage to spring during a bump attack, and the ability to provide forensic evidence, as evidenced by the following description of embodiments.

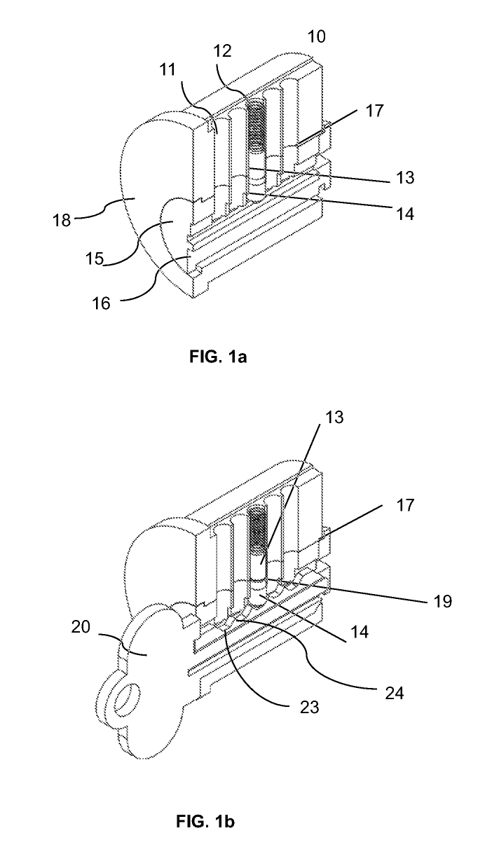

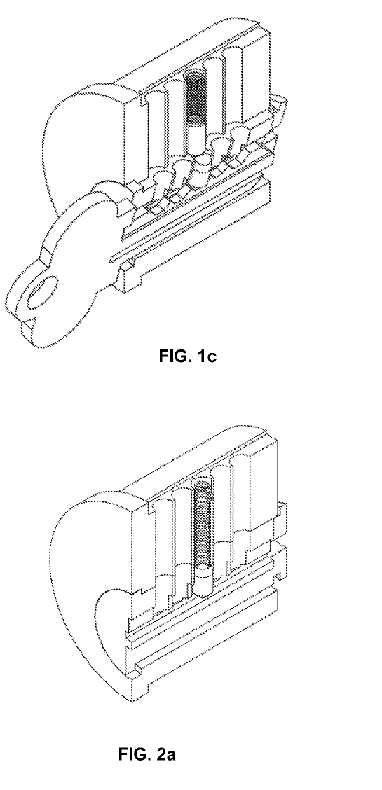

The classical pin tumbler lock is well known. To facilitate the explanation of one or more aspects of the present invention, elements of a pin tumbler lock and some functions will be described, though it is believed that the pin tumbler lock is well known and that one of ordinary skill does not require such an explanation. FIG. 1a shows a perspective cutaway drawing of a pin tumbler lock 10. The lock 10 contains a shell 18, and through the shell a longitudinal opening for a rotatable plug 15, which can rotate along the longitudinal axis. The shell also has one or more radial chambers 11, perpendicular to the longitudinal axis. Each chamber contains at least two pins. Master keyed locks have more than two pins. It is fully contemplated that aspects of the invention as provided herein can also be used in master keyed cylinders.

To not clutter the drawings only one or some of the chamber are shown in populated form.

A chamber contains a spring 12, a top pin (also referred to as driver pin and counter pin) 13 and a combination pin (also referred to as the tumbler pin) 14. Top pin 13 and combination pin 14 touch with the lock in neutral position, but are not physically connected and can move separately. The spring 12 pushes the pins down in neutral position.

The lock has a keyway 16 in the plug, enabled to receive a key. If no pins were present the plug is rotatable along the longitudinal axis along a shear-line 17. In a neutral situation, with no key present, the pins are pushed down in such a manner that the top pin in a chamber crosses the shear line and thus blocks the plug from being rotated inside the shell.

FIG. 1b shows the lock of FIG. 1a with a key 20 inserted. The key is shaped or cut in such a way that troughs 24 and steeples 23 provide a saw tooth like profile. The steeples 23 and troughs 24 of the profile of the key push against the bottom of the combination pin 14, which pushes against the top pin 13, which pushes against the spring 12. When the key 20 has the correct shape it pushes pins 13 and 14 up to exactly the position wherein the line of contact 19 between the pins coincides with the shear line 17, in which case the pins 13 and 14 no longer block the plug from being rotated along the longitudinal axis. When the pins in all chambers have their separation line coincide with the shear line 17 the plug 15 can be rotated and the lock can be opened as is shown in FIG. 1c.

One can easily see that all pins have to be positioned correctly to open the lock. To have the pins positioned correctly requires the pins being lifted in the proper amount which is done by the correct key. One cannot see from the outside what the correct “lift” of each pin set is supposed to be. So only people with a correct key will be able to open the lock.

Key bumping defies the assumption of security as it enables to create by impact the top pins to be separated from the combination pins and to create a contiguous separation gap between all the top pins and combination pins that coincides with the shear line. This allows the opening of the pin tumbler lock without using a proper key.

The tools required for a bumping attack are quite simple: a bump key to match the lock's keyway and pin count with each cut at its maximum allowable depth, sometimes called a “999” key and a bumping tool such as the head of a screw driver. The “Tomahawk” is a commercially available device specifically designed for bumping locks.

The bump attack process usually comprises the following steps:
Insert bump key into lock and withdraw the key one pin position;
Place slight torque on the bump key; and
Strike the bump key with the bump tool.
   The above steps if done correctly on a vulnerable lock, can allow a complete novice to open the lock with a surprisingly few number of strikes.

To counter opening of a lock by bumping as an aspect of the present invention an improved pin tumbler lock is provided that is more resistant to key bumping attacks than currently available or unimproved pin tumbler locks. In one aspect of the present invention, an improved lock with an improved resistance to a key bumping attack is derived from a corresponding standard lock or unimproved lock with the same outside dimensions as the improved lock. As an aspect of the present invention one can replace an existing lock with an improved lock. This is beneficial in situations wherein a lock is part of a lock housing, such as in a door, wherein replacing the complete housing would be expensive. The replaceable part in one embodiment of the present invention is the lock which is generally a cylinder lock. In another embodiment of the present invention one may change components in the lock, for instance the top pins and springs, to improve bumping resistance, without having to exchange the complete lock and allowing to keeping using the same key.

The dimensions of a pin of a standard pin tumbler lock are substantially determined by the key that is authorized to open the lock. Such a key has a profile with cuts that define troughs and steeples. A pin tumbler lock has a pin configuration that straddles the shear line between the shell and the plug of a cylinder lock when no key is inserted or when the wrong key is inserted and wherein the separation line between top pins and combination pins matches the shear line of the lock when the correct key is inserted in the keyway. An improved pin tumbler lock can be compared to an unimproved pin tumbler lock wherein both the improved and unimproved lock are matched and can be opened in an authorized manner by the same key. In such a comparison all the external dimensions of the improved and unimproved lock may be considered to be identical. At least a pin, and preferably a top pin applied in the improved lock is different from a corresponding top pin in a corresponding unimproved lock. The bottom or combination pins in improved and unimproved lock may remain the same. While the improved and unimproved lock may have the same combination pins, one may also provide other combination pins. In the context of the present description, an improved and unimproved pin tumbler lock may be assumed to have corresponding combination pins with the same dimensions, unless stated otherwise.

A plug has a chamber and a shell has a chamber, the two chambers in a neutral key position are connected to form one contiguous chamber wherein combination pin and top pin can move up and down. One may call such a chamber comprised of a chamber of a shell aligned with a chamber of a plug a common chamber.

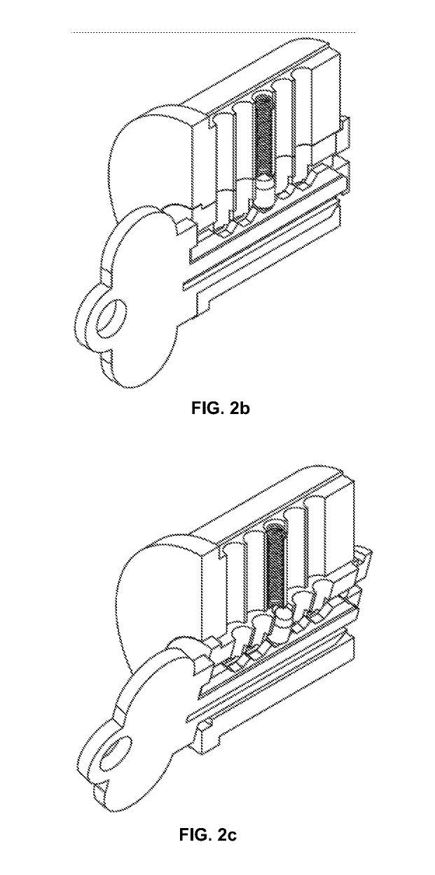

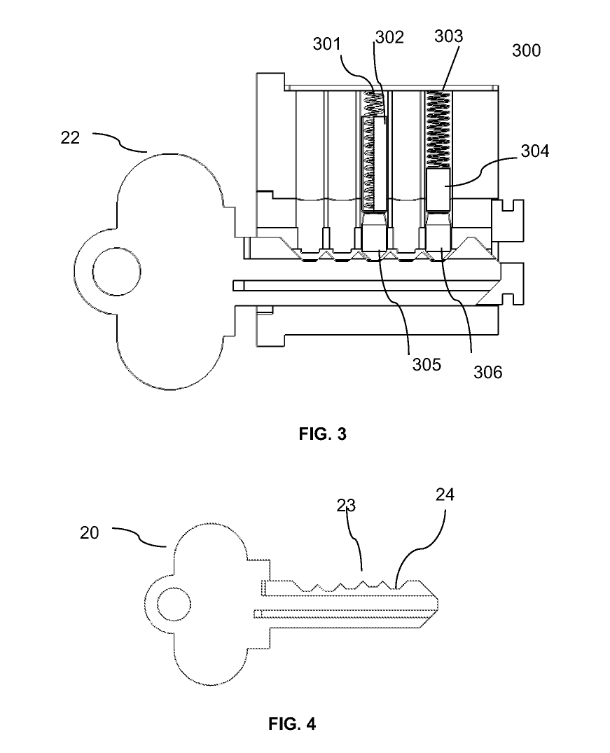

In accordance with a further embodiment of the present invention the ratio in mass between a top pin and a combination pin in an improved lock in a chamber is significantly diminished compared to a ratio in mass between a combination pin and a top pin in an unimproved lock (mass ration of unimproved pin and combination pin typically is close to 1:1). In one embodiment of the present invention the decreasing of the mass ratio is achieved by using an improved top pin in the improved lock that is a cylinder shell as is for instance shown in FIG. 8a. One is also referred to FIG. 3 which illustrates an improved top pin 302, which is clearly a hollow cylinder with a feature on its bottom to retain a spring lip and its associated spring 301. FIG. 3 also shows for comparison an unimproved pin 304, which is a solid cylinder. In one embodiment of the present invention a top pin in FIG. 3 top pins 302 and 304 have different dimensions, while having identical or substantially identical combination pins 305 and 306. FIG. 2 is an isometric view of FIG. 3.

FIG. 4 illustrates a cut key known to be useful in the locks described herein. FIG. 5 is a bump key with all cuts made to the deepest setting. This key sometimes referred to as a 999 key.

In one embodiment of the present invention the improved top pin in an improved lock is substantially less in weight than the corresponding unimproved top pin in an unimproved lock. In a further embodiment of the present invention the improved top pin is about 80% or less in weight than the corresponding unimproved top pin in an unimproved lock. In yet a further embodiment of the present invention the improved top pin is about 60% or less in weight than the corresponding unimproved top pin in an unimproved lock. In yet a further embodiment of the present invention the improved top pin is about 50% or less in weight than the corresponding unimproved top pin in an unimproved lock. In yet a further embodiment of the present invention the improved top pin is about 25% or less in weight than the corresponding unimproved top pin in an unimproved lock. In yet a further embodiment of the present invention the improved top pin is about 10% or less in weight than the corresponding unimproved top pin in an unimproved lock.

In one embodiment of the present invention the improved top pin is about 75% or less in weight than the weight of a combination pin in a common chamber. In yet a further embodiment of the present invention the improved top pin is about 50% or less in weight than the weight of a combination pin in a common chamber. In yet a further embodiment of the present invention the improved top pin is about 25% or less in weight than the weight of a combination pin in a common chamber. In yet a further embodiment of the present invention the improved top pin is about 10% or less in weight than the weight of a combination pin in a common chamber.

To achieve these above mass ratios (increased differences of weight) for the improved top pin compared to a combination pin one may have to apply a strong material to fabricate the improved top pin with a relatively thin but strong wall. One may further reduce the mass of a top pin by giving it the shape of a hollow walled cylinder with a perforated bottom 803, as is shown in FIG. 8b. Perforation of the bottom may have additional benefits, for instance it may reduce slow down by captured air in the hollow cylinder top pin when being bumped. One may yet further reduce the mass of a top pin by giving it the shape of a hollow walled cylinder with a perforated wall 805, as is shown in FIG. 8e. It may also improve resistance to traditional picking methods by providing a more positive lateral contact the top pin and the combination pin.

Other aspects of the present invention are that the improved top pin length is shorter, the same or longer than the un-improved top pin. FIGS. 8a, 8b and 8c show a longer pin. FIGS. 8d and 8e show an improved pin that is the same length as an unimproved top pin 13. Because the improved top pin is hollow and the spring rests on the bottom of the improved top pin the same spring can be used for the improved top pins of different lengths. Another advantage of the improved top pin is that its associated spring 301 has a longer working length than the spring 303 associated with an unimproved top pin. The increased length enables the use of a compound spring with an improved top pin. The compound spring would have one spring rate and working distance for normal key operation and a second, much higher spring rate to deter a bumping attack. The higher spring rate would absorb energy and it would return the improved top pin back over the shear line more quickly which would shorten the time in which the shear line is not blocked.

The improved top pin is drawn as a hollow cylinder. While a cylinder is a preferred shape for the pin, it is not a required shape. Commonly, a shape of a chamber in a pin tumbler lock is one of a cylinder. The requirement for a top pin is to be able to fit inside a chamber and being able to move up and down in the chamber when a key is inserted or withdrawn. Furthermore, the improved top pin may be of a hollow, tubular structure or tube that is at least partially walled, as part of the wall may be perforated to reduce weight. Accordingly, an improved top pin in one embodiment of the present invention is a hollow, at least partially walled tubular structure or tube that has a circular or substantially circular cross section perpendicular to its longitudinal axis. However, a cylindrical shape is not required as long as the improved top pin has a cross section that allows it to move inside the chamber. In one embodiment of the present invention an improved top pin is a hollow at least partially walled tubular structure or tube that has a cross section perpendicular to its longitudinal axis that allows the pin to move up and down a chamber of the lock. In another embodiment of the present invention the cross section perpendicular to the longitudinal axis of the tube or pin is a circle. In another embodiment of the present invention the cross-section is a square or rectangle. In yet a further embodiment of the present invention the cross section is a polygon. Additionally the pin can be asymmetric in form which would move its center of gravity off its longitudinal axis which would cause a less uniform and organized kinetic event inside the chamber during a bumping attack.

While an improved top pin in one embodiment of the present invention is at least partially hollow, it is fully contemplated that in a further embodiment of the present invention an improved top pin is at least partially solid.

It is one aspect of the present invention is to provide improved pins that behave differently than unimproved top pins during a bumping attack. The more the pins behave differently the longer the time span that the shear line is blocked which shortens or eliminates the window of opportunity for a successful bumping attack.

One embodiment of an improved top pin is shown in FIG. 12 that has an angled bottom surface 26 so that the bottom surface 26 is not flat. The surface 26 is angled upward in this embodiment of the present invention so that when the top pin 1000 meets the combination (bottom) pin, the mating surface is not clean. Thus, the reaction is not necessarily in a straight line. There is a less uniform reaction. It biases the pin to the side during a bumping attack which would change the dynamics. It may also hinder a traditional picking attack. The angle could also be dimensioned to be compatible with bi-axial tumbler locks such as the Medeco Bi-Axial lock.

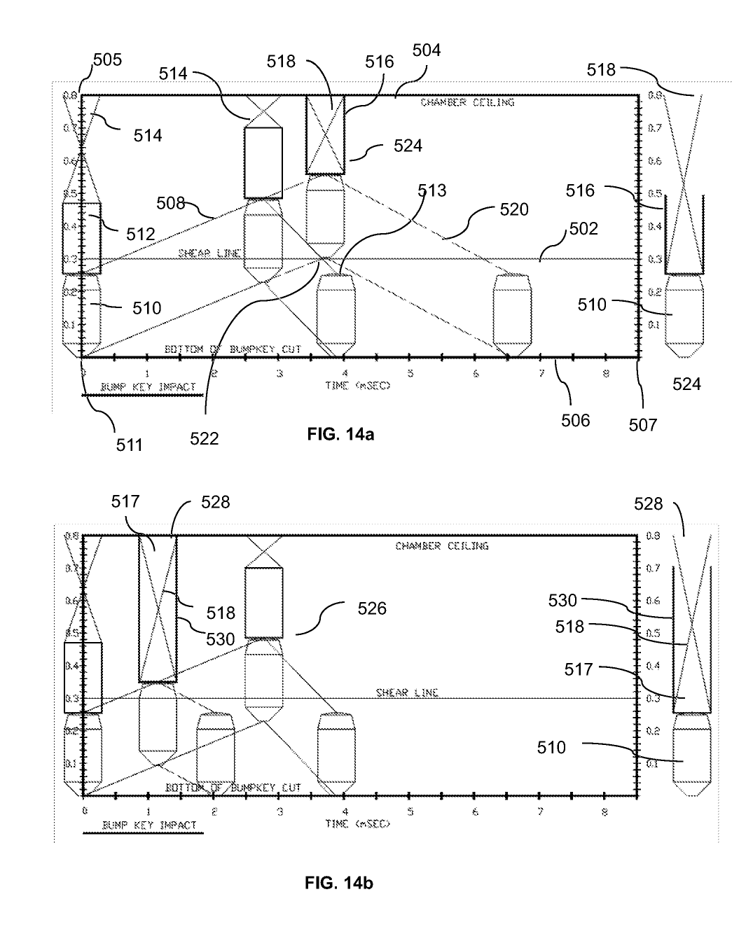

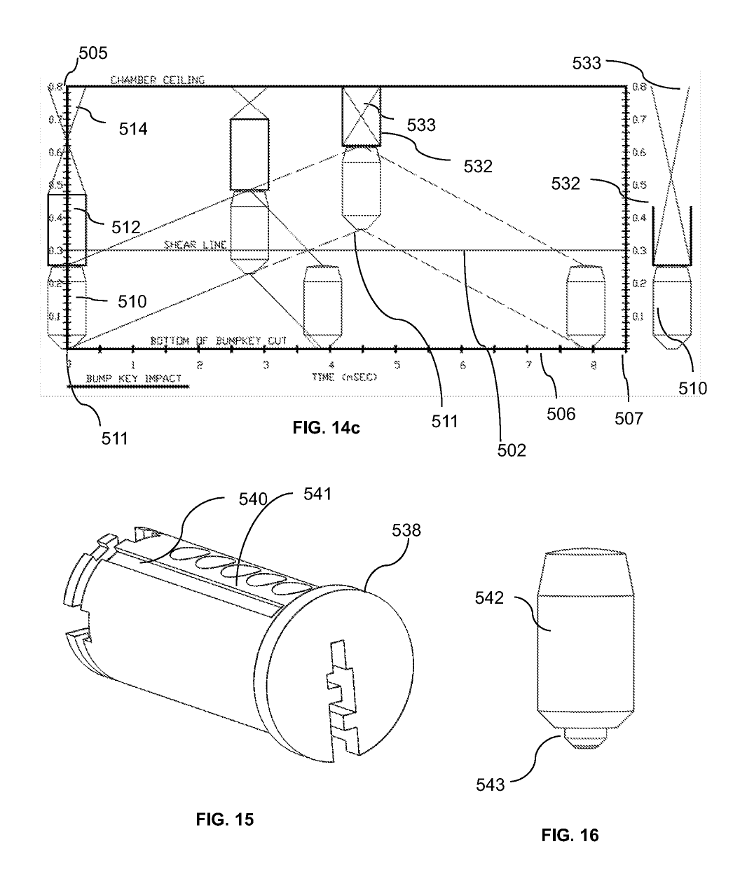

In a one embodiment of the present invention the improved top pin which is a hollow cylinder is longer than the corresponding top pin in the unimproved lock as shown in FIG. 14b. This may reduce the distance traveled by a bumped top pin and send back a bumped combination pin in a shorter period of time from the top position to the bottom position than in the unimproved lock, because the travel distance may be reduced measurably. This further reduces the time and opportunity of the existence of a gap around the shear line. In one embodiment of the present invention the improved top pin is longer than the corresponding unimproved pin. In yet a further embodiment of the present invention the improved top pin is at least about 25% longer than the corresponding unimproved pin. In yet a further embodiment of the present invention the improved top pin is at least 50% longer than the corresponding unimproved pin. In yet a further embodiment of the present invention the improved top pin is at least about 100% longer than the corresponding unimproved pin. In yet a further embodiment of the present invention the improved top pin is at least about 25% longer than the combination pin in a common chamber that combination pin and improved top pin share. In yet a further embodiment of the present invention the improved top pin is at least about 50% longer than the combination pin in a common chamber that combination pin and improved top pin share. In yet a further embodiment of the present invention the improved top pin is at least about 75% longer than the combination pin in a common chamber that combination pin and improved top pin share. In yet a further embodiment of the present invention the improved top pin is at least about 100% longer than the combination pin in a common chamber that combination pin and improved top pin share.

A longer top pin is illustrated in FIG. 3, FIG. 8a, FIG. 8b, FIG. 8c and FIG. 14b. The amount that an improved pin can be longer than a corresponding pin depends also on how much of a chamber of an unimproved shell of an unimproved lock is already occupied by an unimproved pin. This occupation rate varies by brand, size and configuration of a lock. In some cases a top pin may occupy about 25% of a chamber in a shell. In that case one may create an improved top pin that is 100% or longer than the unimproved pin. In one case an unimproved pin occupies about 50% of the chamber in an unimproved lock. In that case an improved top pin can physically not be taller than 100% of the unimproved pin, as it would then not be possible to open the lock without collapsing the improved top pin.

In a one embodiment of the present invention the improved top pin which is a hollow cylinder is shorter than the corresponding top pin in the unimproved lock, as shown in FIG. 14a. This may increase the distance traveled by a bumped top pin and send back a bumped combination pin in a longer period of time from the top position to the bottom position than in the unimproved lock, because the travel distance may be increased measurably. This further reduces the time and opportunity of the existence of a gap around the shear line. In one embodiment of the present invention the improved top pin is shorter than the corresponding unimproved pin. In yet a further embodiment of the present invention the improved top pin is at least about 25% shorter than the corresponding unimproved pin. In yet a further embodiment of the present invention the improved top pin is at least 50% shorter than the corresponding unimproved pin. In yet a further embodiment of the present invention the improved top pin is at least about 75% shorter than the corresponding unimproved pin. In yet another embodiment of the present invention the improved top pin has the same outside length of the unimproved top pin but the distance of travel is increased by the fully compressed length of the spring associated with the unimproved top pin, as shown in FIG. 14a. This is because the spring associated with the improved top pin is compressed within the body of the improved top pin.

In a further embodiment of the present invention a combination pin in an improved lock is heavier than a corresponding combination pin in an unimproved lock. This is achieved by making the improved combination pin from a heavier or denser material than the unimproved pin. The improved combination pin in a further embodiment of the present invention is made heavier by increasing the size of the pin. In the latter case it is necessary to modify the size of the chamber to accommodate the improved combination pin, and to make sure that the improved combination pin does not exceed the shear line.

An improved top pin and spring can be retro-fitted into an existing pin tumbler lock. In one embodiment of the present invention an improved top pin is provided as part of a kit. A spring may also be provided as part of a kit. In a further embodiment of the present invention the kit also contains instructions how to install the new and improved pin. In yet a further embodiment of the present invention the kit contains packaging of the improved pin.

A common misunderstanding and assumption of the working of a key bump attack is that the top pins will separate from the combination pins upon impact from the bump key. People often use the known “Newton's Cradle” as an illustrative example of what they believe is occurring. They mistakenly believe that a gap is created when the top pin is thrown upward and the combination pin stays in place and that when this gap is formed torque can be applied to the bump key and the lock can be opened. Because bump key steeple acts as a ramp the two pins are thrown upward simultaneously and remain essentially in contact with each other during the upward movement.

The gap is created after the top and combination pins are thrown violently upwards crushing the spring to its fully compressed state and the top pin and the combination pin become separated. Some of the energy of the impact of the pins against the ceiling of the chamber is conserved by the elastic properties of pin material. The dynamics of the collision cause the combination pin to bounce back toward the key before the top pin and the spring recover at about twice the velocity it had going up, creating the gap between top pin and combination pin. This is when the opportunity for bumping occurs.

This dynamic is consistent with the law of Conservation of Linear Momentum, which can be expressed as M_{TP}V_{TP1}+M_{CP}V_{CP1}=M_{TP}V_{TP2}+M_{CP}V_{CP2}

### Where:

M_{TP} is the mass of the top pin;
V_{TP1} is the upward velocity of the top pin;
M_{CP} is the mass of the combination pin;
V_{CP1} is the upward velocity of the combination pin;
V_{TP2} is the downward velocity of the top pin (just after impact with the top of the chamber); and
V_{CP2} is the downward velocity of the combination pin.

Even though the dynamics of the pins and spring in the chamber after being bumped are violent and complex and occur in the span of a few milliseconds the equation above can be used to roughly explain, at least in part, what happens during a bumping attack. To simplify the dynamics assume that the springs mass and spring properties are insignificant and that the combination and top pins have equal mass and material properties.

M_{TP}=M_{CP}=M (Assume the top and combination pins are brass and have equal mass)
V_{TP1}=V_{CP1}⁼V_{UP} (The top and combination pins are thrown upward at the same velocity)
V_{DP2}=0 (The top pin remains stationary just after the 2 pins collide with the top of the chamber)

The equation then reduces to:

2V_{UP}=V_{CP2} (the downward velocity is of the combination pin is twice the upward velocity)

Just after the pins collide with the top of the chamber the combination pin separates from the top pin and returns downward at velocity greater than it had going up. This is the case for the pins in each of the chambers. There is a gap between the top and combination in and there a period of time where all the combination pins are below the shear line and all the top pins are above the shear line. When this situation exists the plug can be rotated and the lock is opened.

One may apply the analysis of the physical aspects of the bumping phenomenon to explain how aspects of the present invention minimize or eliminate the gap of the separation line of top pin and combination pin and how the time that the gap exists is minimized.

The dynamics of the bumping process are modified by modifying or improving the physical characteristics, including size and shape, of a pin, which is preferably a top pin. In one embodiment of the present invention a top pin is altered and is substantially different from an unaltered top pin in such a manner that there is less of a window or no window of opportunity to exploit the separation of the top pin and the combination pin. This is illustrated in FIG. 3. FIG. 3 shows a diagram of a lock 300 with a key in a keyway and 5 pin chambers. For illustrative purposes only chamber 3 from the left and chamber 5 from the left are shown with pins and spring. Chamber 3 shows an altered top pin 302 and spring 301. The altered top pin is hollow walled cylinder. The spring 301 is inside the pin in this embodiment. Chamber 5 shows an unaltered top pin 304 and spring 303. In one embodiment of the present invention the mass of the altered pin is reduced compared to the unaltered pin, which is preferably a top pin. It is one objective to minimize the opportunity for bumping by minimizing or eliminating the gap and it is another objective to minimize the time that the gap exists. This can be achieved in part by creating a pillowing effect of an air pocket between the top of the chamber and the inside bottom of the improved top pin. In one embodiment of the present invention the top pin is made lighter, thinner and thus considerably less efficient in the transfer of energy. The larger volume of air between the top of the chamber and the bottom of the improved top pin will also contribute to it behaving differently than non-altered top pins. One may reduce the mass of a pin, which is preferably a top pin in a tumbler lock, by using a hollow and relatively this walled pin. This reduces the overall mass because no in material is present inside the wall of the pin.

This is illustrated in FIGS. 8a, 8b, 8c, 8d and 8e. FIG. 8a shows in a cutaway diagram a first exemplary embodiment of a pin, which is a hollow cylinder with a surrounding wall 801 and a closed bottom base 802. FIG. 8b shows in a cutaway diagram a second exemplary embodiment of a pin, which is a hollow cylinder with a surrounding wall and a partially open bottom base 803. The base (either completely of partially closed) is required to create a platform for the spring. The mass of the pin may be further reduced by removing parts of the wall 804 as shown in FIG. 8c. One may increase the length of a top pin; one may also keep the length of an improved top pin the same as an unimproved top pin. One may also reduce the length of an improved top pin compared to an unimproved top pin.

One may in one embodiment of the present invention create a platform for the spring inside the pin that is above the position of the base of the pin. One may also create in yet a further embodiment of the present invention a cylinder that is partially hollow and partially solid.

In a further embodiment of the present invention one may also apply lighter materials to achieve reduction in mass. Currently, common materials applied to create pins in pin tumbler locks are for instance steel and brass. In one embodiment of the present invention one may create an improved pin from titanium or steel or a strong polymer.

Energy is transferred from the bump key to the combination pin to the top pin to the spring to the lock body. With existing cylinder chambers without an altered or improved top pin the spring is violently smashed and its properties are diminished with each bumping event. The improved top pin 302 as shown in FIG. 3 prevents the spring from bottoming out. In one embodiment of the present invention an improved pin may have an increased length compared to an unaltered corresponding pin so that its size limits the distance it can travel in the chamber. This increased distance may be different from the un-improved or non-altered top pins. In a further embodiment of the present invention a spring may be a compound spring that can provide a spring rate suitable for normal key operation and a second higher rate to absorb the energy during a bumping attack.

In accordance with a further embodiment of the present invention an improved top pin 830 as shown in FIG. 10 includes a tab 831 to provide forensic evidence of bumping. Under normal key operation the top pin never collides with the top of the chamber. In a bump attack the top of the top pin collides with the roof of the chamber with considerable force, the tab 831 will be configured to deform during this event. Having a tab or an inclined top edge will throw the top pin to the side of the chamber when the pin collides with the top of the chamber during a bumping attack which will absorb additional energy and further alter the dynamics relative to un-improved top pins.

FIG. 11 illustrates a top pin in accordance with another aspect of the present invention. In accordance with this aspect of the present invention, the top pin can include a tapered end at the bottom of the top pin or a bottom section with a radius that is smaller than the body of the top pin, as illustrated. In this case, the narrow bottom section facilitates the top pin falling below the shear line and helps prevent the top pin from becoming snagged on the shear line.

FIG. 13 illustrates a top pin in accordance with another aspect of the present invention. The top pin of FIG. 13 shows a tapered bottom section as previously described with respect to FIG. 11. It also includes a walled section to support the spring, as shown.

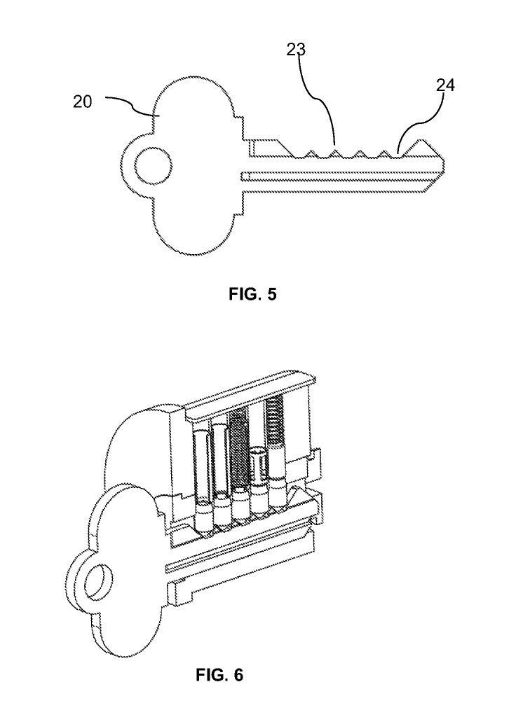

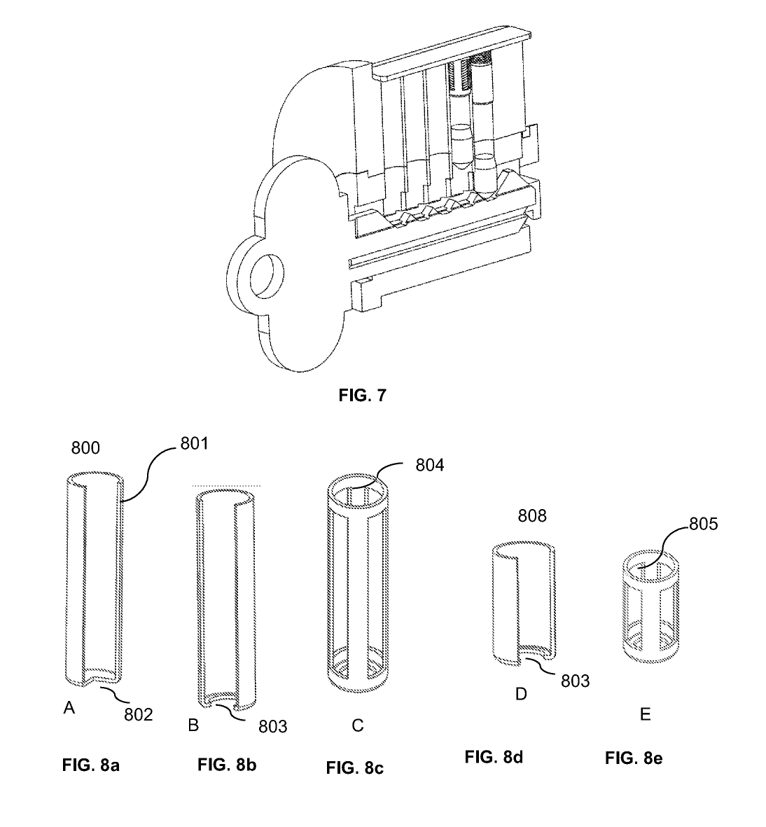

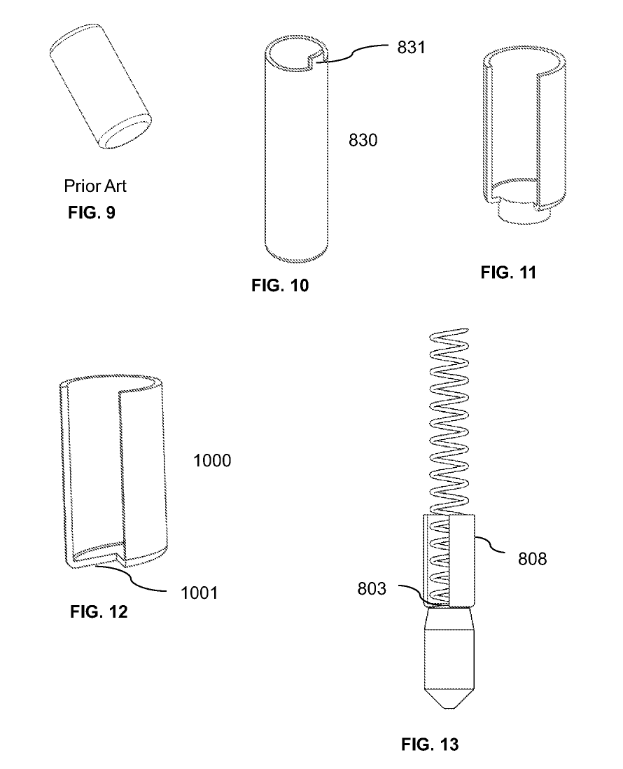

FIGS. 6 and 7 illustrate locks that utilize various top pins in accordance with various aspects of the present invention. These figures also demonstrate that it is possible to use a variety of different top pins in a single lock.

In a further embodiment of the present invention the bottom of the top pin can also be inclined which will further diminish the transfer of energy between the combination pin and top pin as well as alter the dynamics. In a further embodiment of the present invention an improved top pin also has perforations to affect its aerodynamics, further shortening the window of opportunity for a bump attack. The perforations may be symmetric or asymmetric; perforations may also be on the bottom of an improved top pin. Perforations also further reduce the weight relative to un-improved top pins.

In another embodiment of the present invention O-rings are employed. The O-rings may be in the chamber or on the improved top pin. The O-ring may be of a dimension to provide minimal friction between the chamber wall and the side wall of the improved top pin.

The increased volume of the air pocket between the roof of the chamber and the inside bottom of the top pin provide a substantially larger air cushion than the prior art. The larger air cushion absorbs additional energy and further alters the dynamics relative to an un-improved top pin. Furthermore, the improved top pin and spring arrangement is a more efficient use of space, which may allow for a smaller lock cylinder.

When a bump key is bumped the combination and top pins are lifted upward in unison in the direction of the top of the chamber with substantially the same velocity and the top of the combination pin and the bottom of the top pin remain in contact with each other. The spring is fully compressed in a violent manner when the combination and top pin reach the top of the chamber. After only a few bumping events the spring's properties may be severely degraded due to being smashed between the top of the chamber and the top of the top pin.

In one embodiment of the present invention the mass of the top pin is significantly reduced relative to the mass of the combination pin. The improved top pin is a hollow thin walled shell as was discussed above and shown in FIG. 8a-8e. The pin is made of ferrous or non-ferrous metal in one embodiment. It may also be made of polymer or ceramic. Titanium is particularly well suited because of it strength to weight ratio, however, it is more expensive and difficult to machine than other materials. Following is a table showing the volume and weight characteristics of improved top pin embodiments A, B, C and D as shown in FIGS. 8a, 8b, 8c and 8e respectively. Of course other embodiments are possible and are fully contemplated, including different materials, lengths, wall thicknesses, perforation patterns etc. The following table shows reduction in mass one can achieve by using the different shell configurations and by using different materials.

| | | Improved Top Pin | | | | | | | | | |
|---|---|---|---|---|---|---|---|---|---|---|---|
| | | Stainless Steel | | | | | Titanium Alloy | | | | |
| | Std Top Pin | A | B | C | D | E | A | B | C | D | E |
| Volume (IN\hat{ }3) | 0.00202 | 0.0013 | 0.00127 | 0.00062 | 0.00062 | 0.00036 | 0.0013 | 0.00127 | 0.00062 | 0.00062 | 0.00036 |
| Weight (LB × 10\hat{ }−3 | 0.608 | 0.361 | 0.353 | 0.172 | 0.172 | 0.100 | 0.208 | 0.203 | 0.099 | 0.099 | 0.058 |
| Weight ratio | 1 | 0.59 | 0.58 | 0.28 | 0.28 | 0.16 | 0.34 | 0.33 | 0.16 | 0.16 | 0.09 |

The table above assumes that the standard top pin is brass. The weight calculations use the following densities:

TABLE 2

| Material | density (lb/in\hat{ }3) |
|---|---|
| Brass | 0.301 |
| Stainless | 0.278 |
| Titanium | 0.160 |

The weight ratio in the above table is weight of the improved top pin divided by the weight of the unimproved or standard top pin. It is assumed that the combination pin is the same weight as an unimproved top pin. Using the assumptions above the downward velocity of the combination pin (VCP2) approximately equals: (V_{P}*(1+weight ratio)). For example a stainless steel improved top pin, with a configuration of embodiment E as shown in FIG. 8e will have a downward velocity about 1.2 times the upward velocity (based on the assumptions discussed earlier).

By installing at least one improved top pin in one chamber of a multi-pin pin tumbler lock the lock cylinder vulnerability to a bumping attack is reduced because the gap across the shear produced by the separation of top and combination pins is reduced by the combination pins having a substantially different downward velocity. Also the shear line is blocked by the combination pins for a longer period of time.

FIG. 14a is a chart that shows the position of combination pins and their associated top pins position in inches with respect to time in mSECs (1×10⁻³ seconds). Some of the data to construct the chart was obtained empirically including the initial velocity of the pins. The dimensions are typical of common, commercially off the shelf pin tumbler lock mechanisms. On the vertical axis 505 the position of 0.0 IN, 500, represents the bottom of the cut 24 on a bump key 22. This is where the end of a combination pin 511 rests when the bump key 22 is inserted into the plug 15 and before the bumping event.

The horizontal line 502 at about 0.30 IN. represents the location of the shear line which is about 0.3 inches about the bottom of the cut on the bump key and 0.50 IN from the chamber's ceiling. The top horizontal line 504 represents the top of the chamber and is typically about 0.50 IN above the shear line 502 and 0.80 IN above the bottom of the cut 24 on the bump key 22.

The horizontal axis 506 is in mSECs and goes from 0.0 to 8.5 mSECs. Data obtained empirically show that when rapped the bump key travels about 0.16 IN in about 1.85 mSECs which translates to a velocity of about 84 IN/SEC. Typically the bump key steeples 23 are at 45 Degrees so the initial upward velocity of the pins is equal to the inward velocity of the bump key 22, about 84 IN/SEC and is represented by the slope of the line 508. If all the steeples 23 are at the same angle all the pins in a pin tumbler lock will have the same initial velocity during a bumping attack. Of course initial velocities for specific pin chambers can be tuned by changing the angles of the specific cuts. The steeples on the bump key 22 and the pins are assumed to be equally spaced so the pins are lifted simultaneously.

Superimposed on the left vertical axis of the chart is a stack composed of a combination pin 510, 0.255 IN long, an un-improved drive pin 512, 0.220 IN long with an inside cavity 217 of 0.21 IN in length and a spring 514 which is depicted having an initial compress height of about 0.33 IN. A typical spring for an unimproved drive pin in a pin tumbler lock has a free length of about 0.38 IN and a spring rate of about 0.6 LB/IN. This translates into in initial force of about 0.03 LB.

On the right side of FIG. 14a is a stack 524 that represents a combination pin 510, an improved drive pin 516 the same length as the un-improved top pin 512, and it associated spring 518. The springs in charts 14a, 14b and 14c are represented by a simple ‘X’. The stack 524 is shown next to the right vertical axis 507 to show the dimensions and the positions of the stack's components when the bump key 22 is inserted into the keyway 16 but prior to the bumping event, it is not associated with the time axis 506. This spring 518 may be a commercial off the shelf item such as Lee Spring part number CL010B09S316 which has a free length of 0.631N, a fully compressed height of 0.2051N and a spring rate of 1.5 LB/IN. The spring 518 is depicted with an initial compressed height of about 0.5351N. This initial height equals the distance from bottom of cut on the bump key to the ceiling of the chamber less the height of the combination pin 510 and floor thickness of the improved pin 516, which is assumed to be 0.011N for this example. This translates to an initial force of about 0.14 LB.

Combination pins vary in length in about 0.012 IN increments, so different combination pins will result in different initial forces. It is contemplated that a compound spring could be used with an improved top pin to provide a working spring rate for normal key operation and a higher spring rate to react against a bumping attack. This working spring rate of a compound spring could be substantially equal to that of the spring associated with the unimproved pin which would make detection of the chamber with the improved top pin more difficult.

The stack of pins 526 shown at about 2.7 mSEC represents an un-improved top pin 512 a fully compressed spring 514 and a combination pin 510 topped out on the chamber ceiling 504. It is at this point in time that the combination pin 510 ricochets back toward the bump key 22. Observation shows that it returns downward at about twice its upward velocity and is depicted by the downward slope of line 520. An attempt to explain this phenomenon is located elsewhere in this specification.

The top of the combination pin 513 associated with the un-improved top pin crosses the shear line 502 at location 522 which is about 3.6 mSEC in this simplified chart. Some assumptions were made to simplify this chart including the assumption that all the collisions are perfectly elastic and all velocities are constant. However, even with these assumptions the chart is useful to illustrate the relative times and distances traveled by the pins. The upward velocity is easier to measure empirically than the downward velocities.

The location 522 at which the top of the combination pins associated with un-improved top pins cross the shear line 502 will be different for different length combination pins. For example if the shortest combination pin were 0.060 IN shorter than the longest combination in a lock depicted by this chart, the shorter pin would cross the shear line about 1 mSEC after the longest pin. Locks with a larger spread of combination pin lengths are generally harder to bump because the shear line 502 is blocked for a longer period of time.

The stack of pins 524 located at about 3.7 mSEC represents an improved top pin 516 at the point at which in collides with the chamber's ceiling 504. The spring 518 is not fully compressed to its solid height because the cavity 217 of the improved top pin 516 is longer than the spring's solid height of 0.20 IN.

FIG. 14b is a chart of the relative pin positions when the improved top pin 530 is substantially longer than the unimproved top pin 512. The stack 528 of pins at about 1.1 mSEC represents an improved top pin 530 at the point at which in collides with the chamber's ceiling 504. The spring 518 is not fully compressed to its solid height because the cavity 217 of the improved top pin 516 is longer than the spring's solid height of 0.20 IN.

The stack shown on the right side of the chart in FIG. 14b depicts a stack comprised of a longer improved top pin 530, a combination pin 510 and a spring 518, the position of this stack is not associated with the time axis. The distance the longer improved top pin has to travel before colliding with the chamber's ceiling 504 is about 0.10 IN. The distance the un-improved top pin 510 travels about 0.251N until the spring 514 is fully compressed. In this arrangement the combination pin associated with the improved longer top pin returns downward substantially sooner than the top pin associated with the unimproved top pin 512 which decreases the window of opportunity for a successful bumping attack.

FIG. 14c is a chart that depicts an improved top pin 532 that is shorter than the unimproved top pin 512. When the improved top pin is shorter than an unimproved top pin it has further to travel before returning downward which reduces the window of opportunity for a successful bumping attack because the shear line is blocked for a longer period of time.

The downward slope, velocity of the top pins are not shown in FIGS. 14a, 14b and 14c to prevent obscuring other aspects. Although empirical data show that the improved top pin follows its associated combination pin more closely than the unimproved top pins follow their associated combination pins which further reduces the window of opportunity for a successful bump attack.

Another advantage of this embodiment is that when an appropriate spring 533 is used with the improved top pin 532 there is a point in time in which the bottom of the combination pin 511 is above the shear line and the top of the combination pin 513 associated with the unimproved top is below the shear line 502. When this situation exists, the shear line 502 is not blocked and the plug can be rotated even though both the top pin 532 and the combination pin 510 are above the shear line 502. Another embodiment of this invention is a feature to trap a bump key before the plug can be fully rotated to its unlocked position.

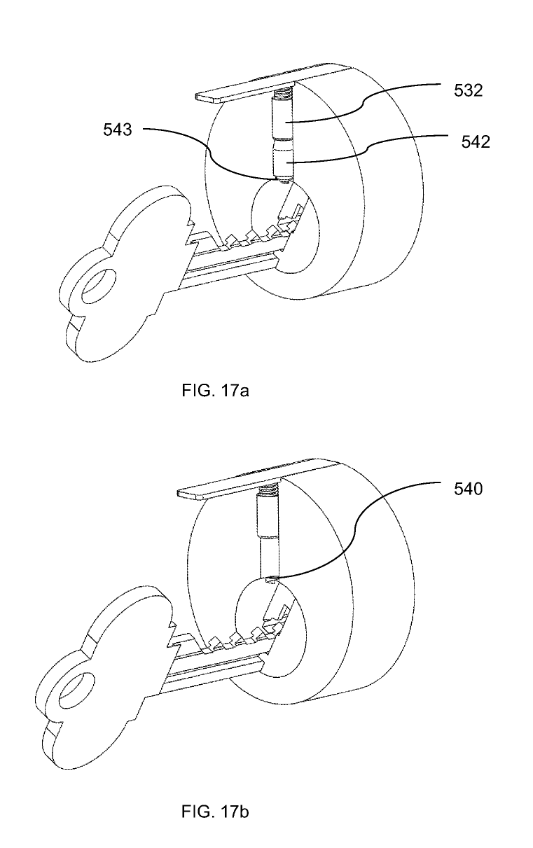

FIG. 15 illustrates a plug 15 with a channel 540 angularly offset from the vertical position. The channel 540 includes 2 walls 541. FIG. 16 illustrates a combination pin 542 with a step 543. FIG. 17a illustrates a section of a plug and shell. The plug 538 is shown partially rotated, about 30 degrees in this illustration. The angle depicted in this illustration is not sufficient to put the lock in an unlocked state. FIG. 17b is the same as FIG. 17a except that the combination pin is not shown for clarity.

After the lock is bumped both the improved top pin and the combination pin are above the shear line and the remaining combination pins are below the shear line and the remaining top pins are above the shear line for short period of time in this embodiment. At this point in time the shear line is not blocked and the plug can be rotated. However, before the plug can be fully rotated to an unlocked position, the modified combination pin 542 returns downward and the step 543 comes in contact with the channel 540 in the plug. The plug can be rotated until the stepped tip 543 of the combination pin 542 falls into the channel 540 which prohibits any further motion of the plug. The bump key is also trapped inside the plug because the other combination pins interfere with the steeples on the bump key and prevent its removal.

This aspect of the invention prevents a successful bump attack, provides evidence of an attempted attack and confiscates the bump key from the malfeasant. To remove the bump key the lock can be disassembled from the rear.

It is contemplated that the channel 540 can be dimensioned so that it would also work with an un-modified combination pin as well.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

We claim:

1. A pin tumbler lock that can be opened with a key that is bump resistant, comprising:
a shell;
a plug secured within the shell so that it can rotate within the shell, the plug having an opening in which the key can be inserted;
a plurality of chambers in the plug, each of the plurality of chambers in the plug containing a combination pin;
a plurality of chambers in the shell, wherein each of the plurality of chambers in the shell are aligned with one of the plurality of chambers in the plug to form a common chamber when the plug and the shell are aligned in a predetermined manner;
a plurality of top pins and a plurality of springs, each of the plurality of chambers in the shell containing one top pin and an associated spring that biases the top pin towards the plug so that when the common chamber is formed the top pin is associated with one of the combination pins; and
wherein at least one of the plurality of top pins has a hollowed section.

2. The pin tumbler lock as claimed in claim 1, wherein the spring associated with the at least one of the plurality of top pins extends into the hollowed section of the at least one of the plurality of top pins.

3. The pin tumbler lock as claimed in claim 1, wherein all of the plurality of top pins have a hollowed section.

4. The pin tumbler lock as claimed in claim 1, wherein the hollowed section extends for an entire length of the at least one of the plurality of top pins.

5. The pin tumbler lock as claimed in claim 1, wherein the at least one of the plurality of top pins that has a hollowed section is also only partially walled.

6. The pin tumbler lock as claimed in claim 4, wherein the at least one of the plurality of top pins that has a hollowed section for its entire length is also only partially walled for its entire length.

7. The pin tumbler lock as claimed in claim 1, wherein the at least one of the plurality of top pins that has a hollowed section has a weight that is about 75% or less of the weight of the combination pin associated with the top pin.

8. The pin tumbler lock as claimed in claim 1, wherein the at least one of the plurality of top pins that has a hollowed section has a weight that is about 50% or less of the weight of the combination pin associated with the top pin.

9. The pin tumbler lock as claimed in claim 1, wherein the at least one of the plurality of top pins that has a hollowed section has a weight that is about 25% or less of the weight of the combination pin associated with the top pin.

10. The pin tumbler lock as claimed in claim 1, wherein the at least one of the plurality of top pins that has a hollowed section has a weight that is about 10% or less of the weight of the combination pin associated with the top pin.

11. The pin tumbler lock as claimed in claim 1, wherein the at least one of the plurality of top pins that has a hollowed section is about 50% longer than a length of the combination pin associated with the top pin.

12. The pin tumbler lock as claimed in claim 1, wherein the at least one of the plurality of top pins that has a hollowed section is about 75% longer than a length of the combination pin associated with the top pin.

13. The pin tumbler lock as claimed in claim 1, wherein the at least one of the plurality of top pins that has a hollowed section is about 100% longer than a length of the combination pin associated with the top pin.

14. The pin tumbler lock as claimed in claim 1, wherein the at least one of the plurality of top pins that has a hollowed section is made of titanium.

15. The pin tumbler lock as claimed in claim 1, wherein the at least one of the plurality of top pins has a tab located away from the combination pin.

16. The tumbler lock as claimed in claim 15, wherein the tab contacts a top of the chamber in the shell to indicate the occurrence of the bumping attack.

17. A pin tumbler lock that can be opened with a key that is bump resistant, comprising:
a shell;
a plug secured within the shell so that it can rotate within the shell, the plug having an opening in which the key can be inserted;
a plurality of chambers in the plug, each of the plurality of chambers in the plug containing a combination pin;
a plurality of chambers in the shell, wherein each of the plurality of chambers in the shell are aligned with one of the plurality of chambers in the plug to form a common chamber when the plug and the shell are aligned in a predetermined manner;
a plurality of top pins and a plurality of springs, each of the plurality of chambers in the shell containing one top pin and an associated spring that biases the top pin towards the plug so that when the common chamber is formed each of the top pins is associated with one of the combination pins; and
wherein at least one of the plurality of top pins is at least 25% lighter than its associated combination pin.

18. The pin tumbler lock as claimed in claim 17, wherein each of the plurality of top pins is at least 25% lighter than the combination pin that it is associated with.

19. The pin tumbler lock as claimed in claim 17, wherein the at least one of the plurality of top pins has a hollowed section

20. The pin tumbler lock as claimed in claim 17, wherein the at least one of the plurality of top pins is made of a material with a weight density that is less than the material that its associated combination pin is made of.
